(19) United States
(12) Patent Application Publication
(10) Pub. No.: US 2007/0000232 A1
(43) Pub. Date: Jan. 4, 2007

(54) Gas turbine engine and method of operating same

(75) Inventors: Brandon Flowers Powell, Mason, OH (US); Bobby Gene Hines, York, SC (US)

Correspondence Address: JOHN S. BEULICK (12729);C/O ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/169,377

(22) Filed: Jun. 29, 2005

(51) Int. Cl. F02K 3/04

(52) U.S. Cl. 60/204; 60/226.1

(57) ABSTRACT

A method for operating a gas turbine engine including a core engine, a fan assembly for pressurizing air, a core stream duct, an inner bypass duct, and an outer bypass duct is provided. The method includes channeling a first portion of air discharged from the fan assembly through the core gas turbine engine, channeling a second portion of the air discharged from the fan assembly through the inner bypass duct such that the second portion of air bypasses the core gas turbine engine, mixing the core gas turbine engine exhaust air and the second portion of air, channeling the mixed air through a core engine nozzle, and channeling a third portion of the air discharged from the fan assembly through a bypass nozzle.

### BACKGROUND OF THE INVENTION

The present invention relates to gas turbine engines and more particularly, to a method and apparatus for controlling gas turbine engine bypass airflows.

At least one known gas turbine engine includes, in serial flow arrangement, a forward fan assembly, a core driven fan assembly, a high-pressure compressor for compressing air flowing through the engine, a combustor for mixing fuel with the compressed air such that the mixture may be ignited, a high pressure turbine for providing power to the high pressure compressor, and a low pressure turbine for providing power to the fan assembly. The high-pressure compressor, combustor and high-pressure turbine are sometimes collectively referred to as the core engine. In operation, the core engine generates combustion gases, which are discharged downstream to a low pressure turbine that extracts energy therefrom for powering the forward fan assembly.

At least one known gas turbine engine has been developed for use in a supersonic transport aircraft (SSBJ). These gas turbine engines must therefore be designed to meet stringent noise, weight, and performance requirements. One such engine is a variable cycle engine (VCE) that is configurable to operate in a double bypass mode. More specifically, the flow modulation potential is increased by splitting the core bypass air into two sections, each in flow communication with a separate concentric bypass duct surrounding the core engine, one duct containing a core driven compressor/fan stage (CDFS). During operation, the bypass ratio, i.e., the ratio of the quantity of airflow bypassing the core engine to that passing through the core engine can be varied by selectively bypassing or flowing air through the CDFS. through various systems of valves and mixers.

Mixing the CDFS exhaust air with the bypass duct stream may limit the controllability of the core-driven fan stage (CDFS) operating line. Accordingly, at least one known gas turbine engine includes a variable area bypass injector device to facilitate reducing the likelihood that potential gas turbine engine operability and stall problems may occur. However, the variable area bypass injector device may reduce the operational efficiency of the core-driven fan stage. For example, when the variable cycle engine is operated in a “single bypass” mode, the engine may experience a relatively substantial dump pressure loss. Moreover, in applications that require relatively stringent acoustic requirements, at least one known gas turbine engine includes an exhaust nozzle that is designed to include relatively large exhaust nozzle variations thus making the exhaust nozzle relatively heavy and complex to design.

### BRIEF DESCRIPTION OF THE INVENTION

In one aspect, a method for operating a gas turbine engine including a core engine, a fan assembly for pressurizing air, a core stream duct, an inner bypass duct, a core driven fan assembly (CDFS) for pressurizing air, and an outer bypass duct is provided. The method includes channeling a first portion of air discharged from the fan assembly through the core gas turbine engine, channeling a second portion of the air discharged from the fan assembly through the CDFS which includes a variable inlet guide vane (VIGV), and into the inner bypass duct such that the second portion of air bypasses the core gas turbine engine, mixing the core gas turbine engine exhaust air and the second portion of air, channeling the mixed air through a core engine nozzle, and channeling a third portion of the air discharged from the fan assembly through a bypass nozzle.

In another aspect, a gas turbine engine assembly is provided. The gas turbine engine assembly includes a core gas turbine engine, a fan assembly for pressurizing air, a core stream duct in flow communication with the fan assembly and configured to receive a first portion of air discharged from the fan assembly, a CDFS and inner bypass duct assembly in flow communication with the fan assembly, wherein the inner bypass duct is positioned radially outward from the core gas turbine engine and configured to receive a second portion of air discharged from the fan assembly and contains a CDFS for the purpose of providing additional pressurization to that provided by the fan assembly, and an outer bypass duct in flow communication with the fan assembly, wherein the outer bypass duct positioned radially outward from the inner bypass duct and configured to receive a third portion of air discharged from the fan assembly.

### BRIEF DESCRIPTION OF THE DRAWINGS

FIG. 1 is a schematic illustration of an exemplary gas turbine engine;

FIG. 2 is schematic illustration of the gas turbine engine shown in FIG. 1 in a first operational configuration;

FIG. 3 is schematic illustration of the gas turbine engine shown in FIG. 1 in a second operational configuration;

FIG. 4 is schematic illustration of the gas turbine engine shown in FIG. 1 in a third operational configuration and

FIG. 5 is schematic illustration of the gas turbine engine shown in FIG. 1 in a fourth operational configuration.

### DETAILED DESCRIPTION OF THE INVENTION

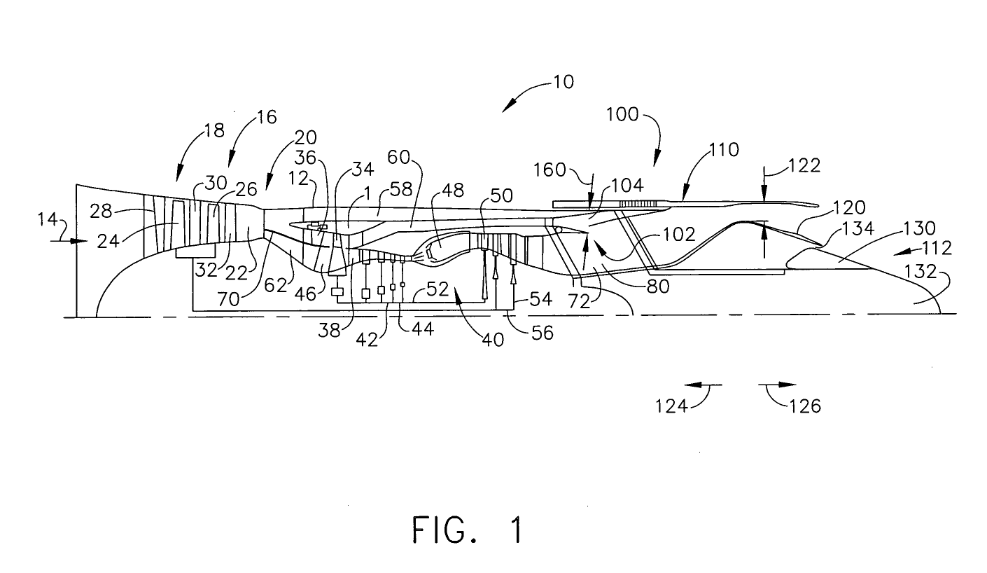

FIG. 1 is a cross-sectional view of a portion of an exemplary gas turbine engine 10 that includes an outer casing or nacelle 12, the upstream end of which forms an inlet 14 that is sized to provide a predetermined quantity of airflow to the engine 10. Disposed within inlet 14 is a fan 16 for receiving and compressing the airflow delivered by inlet 14.

Gas turbine engine 10 also includes a core engine 40, that is positioned downstream of fan 16. In the exemplary embodiment, core engine 40 includes an axial flow compressor 42, with an extended tip on the first stage to operate as the CDFS 34, having a rotor 44.

During operation, air compressed by fan 16 is channeled through a core engine inlet duct 46, and is further compressed by the axial flow compressor 42. The compressed air is then discharged to a combustor 48 where fuel is burned to provide high-energy combustion gases to drive a core engine turbine 50. Turbine 50, in turn, drives the rotor 44 through a shaft 52 in the normal manner of a gas turbine engine. The hot gases of combustion then pass to and drive a low-pressure turbine 54, which, in turn, drives the fan 16 through shaft 56.

In the exemplary embodiment, gas turbine engine 10 also includes two bypass ducts. More specifically, gas turbine engine 10 includes an outer bypass duct 58 that is radially inward of outer casing 12, and an inner bypass duct 60 that is positioned radially inward of outer bypass duct 58, to facilitate bypassing a portion of the fan airflow around core engine 40. In the exemplary embodiment, outer bypass duct 58 and inner bypass duct 60 substantially circumscribe core gas turbine engine 10.

During operation, and in the exemplary embodiment, air is channeled from fan 16 through axial space 22 wherein the airflow is separated into a plurality of flowpaths. Specifically, a first portion of the airflow is channeled through outer bypass duct 58 and aft towards a nozzle assembly 100. A second portion of the air is channeled through CDFS 34 and inner bypass duct 60, that is radially outward of a splitter 70, and aft toward a variable area bypass injector (VABI) 102, and a third portion of the air is channeled to core gas turbine engine 40. Accordingly, as described herein, the air supplied from fan 16 is separated into three separate flowpaths within gas turbine engine 10.

In the exemplary embodiment, the airflow channeled through inner bypass duct 60 is combined and/or mixed with the core engine combustion gases exiting low-pressure turbine 54 utilizing VABI 102. Moreover, the airflow channeled through outer bypass duct 58 is channeled through an exhaust nozzle support strut 104 that is coupled radially aft of core gas turbine engine 10.

Accordingly, and in the exemplary embodiment, gas turbine engine 10 also includes a core nozzle assembly 110, i.e. a core nozzle flap, that is configured to regulate the quantity of combined air that is channeled from VABI 102, and a bypass nozzle assembly 112, i.e. a bypass nozzle flap, that is configured to regulate the quantity of airflow that is channeled from outer bypass duct 58.

In the exemplary embodiment, core nozzle assembly 110 includes a core nozzle valve 120, i.e. a plug, that is coupled to outer casing 12. In one embodiment, core nozzle assembly 110 is a variable area core nozzle assembly wherein actuation is accomplished using various mechanical devices to vary the size of a throat area 122. For example, core nozzle valve 120 may be a flap actuated using a hinge (not shown). In the exemplary embodiment, core nozzle valve 120 is translatable in an axially forward direction 124 and an axially aft direction 126. In an alternative embodiment, core nozzle valve 120 is fixedly coupled to outer casing 12.

In use, core nozzle valve 120 controls the size of throat area 122 to facilitate regulating a quantity of air channeled through throat area 122. More specifically, and in the exemplary embodiment, core nozzle valve 120 is translated in forward direction 124 to facilitate increasing a quantity of airflow that is channeled through throat area 122. Alternatively, core nozzle valve 120 is translated in aft direction 126 to facilitate decreasing the quantity of airflow channeled through throat area 122. Accordingly, core nozzle assembly 110 facilitates regulating the quantity of airflow that is channeled from VABI 102 to the exhaust.

In the exemplary embodiment, bypass nozzle assembly 112 includes a bypass nozzle valve 130, i.e. a plug, that is coupled to an engine centerbody 132 for example. In one embodiment, bypass nozzle assembly 112 is a variable area bypass nozzle wherein actuation is accomplished using various mechanical devices to vary the size of a throat area 134. For example, bypass nozzle valve 130 may be a flap actuated using a hinge (not shown). In the exemplary embodiment, bypass nozzle valve 130 is translatable in axially forward direction 124 to and an axially aft direction 126. In an alternative embodiment, bypass nozzle valve 130 is fixedly coupled to centerbody 132.

In use, and in the exemplary embodiment, bypass nozzle valve 130 is movable to facilitate regulating and/or varying a quantity of airflow channeled through throat area 134. More specifically, and in the exemplary embodiment, bypass nozzle valve 130 is translated in forward direction 124 to facilitate increasing a quantity of airflow that is channeled through throat area 134. Alternatively, bypass nozzle valve 130 is translated in aft direction 126 to facilitate decreasing the quantity of airflow channeled through throat area 134. Accordingly, variable area nozzle assembly 120 facilitates regulating the quantity of airflow that is channeled from outer bypass duct 58 to the exhaust without mixing with the gas turbine exhaust.

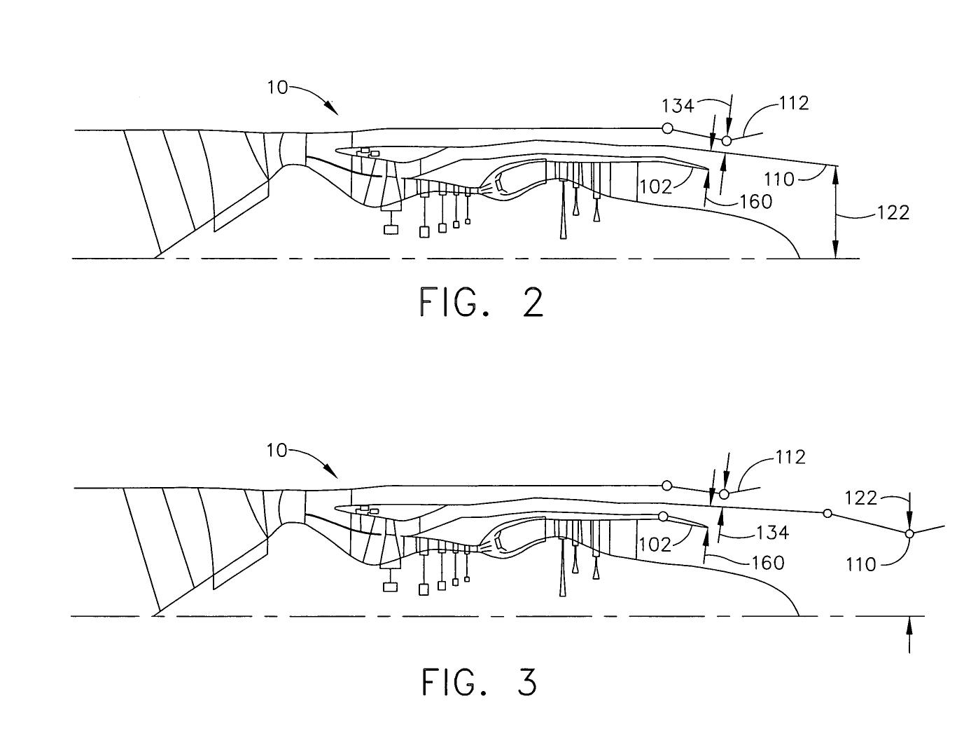

FIG. 2 is schematic illustration of the gas turbine engine shown in FIG. 1 in a first operational configuration. In the exemplary embodiment, VABI 102 and core nozzle assembly 110 are maintained in a fixed position, whereas bypass nozzle assembly 112 is movable to facilitate varying the size of throat area 134.

FIG. 3 is schematic illustration of the gas turbine engine shown in FIG. 1 in a second operational configuration. In the exemplary embodiment, VABI 102, core nozzle assembly 110, and bypass nozzle assembly 112 are all movable to facilitate varying the size of mixer inlet area 160, core throat area 122, and bypass throat area 134 respectively.

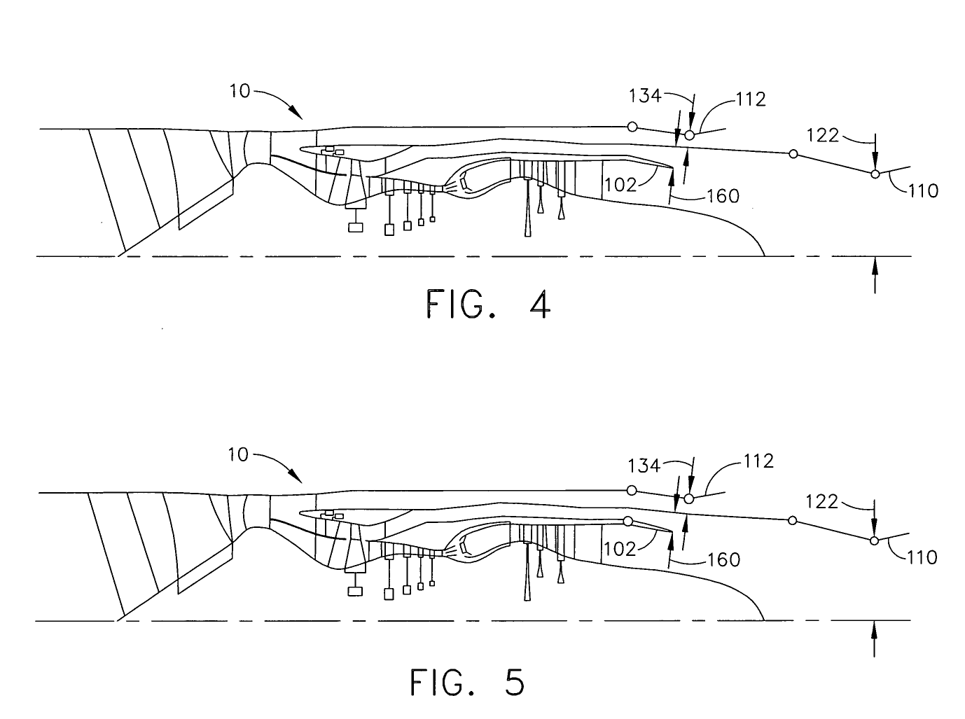

FIG. 4 is schematic illustration of the gas turbine engine shown in FIG. 1 in a third operational configuration. In the exemplary embodiment, VABI 102 is maintained in a fixed position, whereas core nozzle assembly 110 and bypass nozzle assembly 112 are movable to facilitate varying the size of throat area 122 and throat area 134 respectively.

FIG. 5 is schematic illustration of the gas turbine engine shown in FIG. 1 in a fourth operational configuration. In the exemplary embodiment, core nozzle assembly 110 is maintained in a fixed position, whereas VABI 102 and bypass nozzle assembly 112 are movable to facilitate varying the size of mixer inlet area 160 and throat area 134 respectively.

Each of these operational configurations exercises a different combination of variable geometry features. In general, the bypass nozzle assembly 112 is used to control the fan assembly 16 operating pressure ratio, the core nozzle assembly 110 is used to control the CDFS assembly 34 operating pressure ratio, and the VABI 102 is used to control the gas energy extraction of the core assembly 40. The necessity to exercise these features is dependent on the application of the invention. For example, in the supersonic business jet application, where high temperatures limit the flow capacity of the core 40, the fan discharge flow is distributed to the outer bypass duct 58 and the variable bypass nozzle assembly 110 throat area is increased to accept the increased flow without a need to increase core nozzle throat area.

The gas turbine engine assembly described herein facilitates dividing the air produced by the fan assembly into three separate airstreams, i.e. core, inner bypass, outer bypass. The fan tip flow, i.e. outer bypass air is channeled into a dedicated duct and exits through a variable area nozzle, where as air generated by the fan hub and pitch flows are channeled through and around the core gas turbine engine and then mixed utilizing the VABI. More specifically, the hub flow is channeled into the core gas turbine engine and the pitch flow is channeled through the CDFS stage, including variable inlet guide vane. The CDFS flow is then mixed in with the core exhaust flow at the turbine exit. The mixed core flow is then channeled through a separate exhaust nozzle. In the exemplary embodiment, the variable area bypass nozzle is an inverted flow nozzle that facilitates maintaining a relatively low pressure and jet velocity radially inside of the bypass nozzle and a relatively higher jet velocity radially outward of the bypass nozzle therefore decreasing an acoustic signature of the gas turbine engine.

Accordingly, the gas turbine engine described herein facilitates providing the ability to independently specify the fan and CDFS operating lines at the same time, thus allowing for increased thrust per unit airflow at performance levels comparable to standard mixed flow turbofan cycles. In addition, the relatively small amount of flow channeled through the CDFS facilitates reducing the requirement for a variable area mixer and variable core exhaust nozzle, and under some circumstances eliminating them. Moreover, utilizing a separate nozzle for the fan tip flow incorporates many of the benefits associated with a fladed cycle engine, while also decreasing the overall engine weight, thus increasing engine thrust per unit weight over fladed Adaptive Cycle Engines and/or VCE's.

While the invention has been described in terms of various specific embodiments, those skilled in the art will recognize that the invention can be practiced with modification within the spirit and scope of the claims.

What is claimed is:

1. A method for operating a gas turbine engine including a core engine, a fan assembly for pressurizing air, a core stream duct, an inner bypass duct, and an outer bypass duct, said method comprising:
channeling a first portion of air discharged from the fan assembly through the core gas turbine engine;
channeling a second portion of the air discharged from the fan assembly through the inner bypass duct such that the second portion of air bypasses the core gas turbine engine;
mixing the core gas turbine engine exhaust air and the second portion of air;
channeling the mixed air through a core engine nozzle; and
channeling a third portion of the air discharged from the fan assembly through a bypass nozzle.

2. A method in accordance with claim 1 wherein mixing the core gas turbine engine exhaust air and the second portion of air comprises mixing the core gas turbine engine exhaust air and the second portion of air using a variable area bypass injector.

3. A method in accordance with claim 2 further comprising channeling the air discharged from the variable air bypass injector through the core engine nozzle.

4. A method in accordance with claim 3 further comprising varying a throat area of the core engine nozzle to facilitate regulating a quantity of air that is discharged from the variable air bypass injector.

5. A method in accordance with claim 4 further comprising translating the core engine nozzle in at least one of a forward and an aft direction to facilitate regulating a quantity of air that is discharged from the variable air bypass injector.

6. A method in accordance with claim 4 further comprising:
using the variable area bypass injector to regulate the ratio of pressure between the second portion of fan discharge air and the core exhaust air; and
using only the core engine nozzle to facilitate regulating a quantity of air that is discharged from the variable air bypass injector.

7. A method in accordance with claim 1 wherein the outer bypass duct is positioned radially outward from the inner bypass duct, said method further comprising channeling the third portion of the air discharged from the fan assembly through a hollow strut such that the third portion of air discharged from the fan assembly is substantially separated from the portion of air discharged from the variable area bypass injector.

8. A method in accordance with claim 7 further comprising varying a throat area of the bypass nozzle to facilitate regulating a quantity of air that is discharged from the fan assembly.

9. A method in accordance with claim 8 further comprising translating the bypass nozzle in at least one of a forward and an aft direction to facilitate regulating a quantity of air that is discharged from the fan assembly.

10. A method in accordance with 9 wherein said bypass nozzle is movably coupled to an engine centerbody, said method further comprises translating the bypass nozzle in at least one of a forward and an aft direction to facilitate regulating a quantity of air that is discharged from the fan assembly.

11. A gas turbine engine assembly comprising:
a core gas turbine engine;
a fan assembly for pressurizing air;
a core stream duct in flow communication with said fan assembly and configured to receive a first portion of air discharged from said fan assembly;
an inner bypass duct in flow communication with said fan assembly, said inner bypass duct positioned radially outward from said core gas turbine engine and configured to receive a second portion of air discharged from said fan assembly; and
an outer bypass duct in flow communication with said fan assembly, said outer bypass duct positioned radially outward from said inner bypass duct and configured to receive a third portion of air discharged from said fan assembly.

12. A gas turbine engine assembly in accordance with claim 11 further comprising a variable area bypass injector that is configured to mix an exhaust air from said core gas turbine engine with said second portion of air discharged from said fan assembly.

13. A gas turbine engine assembly in accordance with claim 12 wherein said core engine nozzle comprises is movable to facilitate regulating a quantity of air that is discharged from the variable air bypass injector.

14. A gas turbine engine assembly in accordance with claim 13 wherein said core engine nozzle is movable in at least one of a forward and an aft direction to facilitate regulating a quantity of air that is discharged from the variable air bypass injector.

15. A gas turbine engine assembly in accordance with claim 14 wherein said variable area bypass injector is movable to regulate the pressure ratio between said core exhaust air and said second portion of fan discharge air, and core engine nozzle is movable to facilitate regulating a quantity of air that is discharged from the variable air bypass injector.

16. A gas turbine engine assembly in accordance with claim 11 wherein said outer bypass duct is positioned radially outward from said inner bypass duct.

17. A gas turbine engine assembly in accordance with claim 16 further comprising a substantially hollow strut that is configured to receive the third portion of air discharged from said fan assembly and channel the third portion of air to exhaust substantially separated from the portion of air discharged from the variable area bypass injector.

18. A gas turbine engine assembly in accordance with claim 17 wherein said bypass nozzle comprises a variable throat area to facilitate regulating a quantity of air that is discharged from said fan assembly.

19. A gas turbine engine assembly in accordance with claim 18 wherein said bypass nozzle is movable in at least one of a forward and an aft direction to facilitate regulating a quantity of air that is discharged from said fan assembly.

20. A gas turbine engine assembly in accordance with claim 19 wherein said bypass nozzle is movably coupled to an engine centerbody and movable in at least one of a forward and an aft direction to facilitate regulating a quantity of air that is discharged from said fan assembly.
